(19) United States
(12) Patent Application Publication
(10) Pub. No.: US 2014/0268644 A1
(43) Pub. Date: Sep. 18, 2014

(54) CONVERTER ARRANGEMENT, METHOD FOR PRODUCING THE CONVERTER ARRANGEMENT AND LIGHTING ARRANGEMENT

(71) Applicant: Dirk Berben, Herdecke (DE)

(72) Inventor: Dirk Berben, Herdecke (DE)

(73) Assignee: OSRAM GMBH, Muenchen (DE)

(21) Appl. No.: 14/352,062

(22) PCT Filed: Sep. 14, 2012
(86) PCT No.: PCT/EP2012/068174

§ 371 Date: Apr. 16, 2014

(30) Foreign Application Priority Data
Oct. 21, 2011 (DE) 102011084949.1

(51) Int. Cl. F21V 29/00; F21V 9/16

(52) U.S. Cl. CPC F21V 29/002; F21V 9/16
USPC 362/84; 362/351; 156/67

(57) ABSTRACT

A converter arrangement may include a converter element, including crystal or ceramic, having at least one luminescent substance, and a cooling element for dissipating heat from the converter element, wherein the converter element and the cooling element are connected in direct physical contact with one another. A method for producing a converter arrangement is also disclosed. A converter element including crystal or ceramic, having at least one luminescent substance, for dissipating heat from the converter element, is connected to a cooling element such that the converter element and the cooling element are physically in direct contact with one another.

### RELATED APPLICATIONS

The present application is a national stage entry according to 35 U.S.C. §371 of PCT application No.: PCT/EP2012/068174 filed on Sep. 14, 2012, which claims priority from German application No.: 10 2011 084 949.1 filed on Oct. 21, 2011, and is incorporated herein by reference in its entirety.

### TECHNICAL FIELD

Various embodiments relate to a converter arrangement, which includes a converter element having at least one luminescent substance and a cooling element for dissipating heat from the converter element. Furthermore, various embodiments relate to a method for producing the converter arrangement and a lighting arrangement which includes the converter arrangement.

### BACKGROUND

Currently, energy-efficient and high-intensity light sources such as LEDs (light-emitting diodes) or lasers, typically in the form of laser diodes, are increasingly used in modern lighting units. In contrast to incandescent lamps, which are thermal radiators, these light sources emit light in a narrowly limited spectral range, so that the light thereof is practically monochromatic. One possibility for opening up further spectral ranges is, for example, light conversion, in which luminescent substances are irradiated by means of LEDs and/or laser diodes and in turn emit light of another wavelength by way of the wavelength conversion occurring in the luminescent substance. In so-called “remote phosphor” applications, for example, a phosphor-containing layer located at a distance from a light source is typically lighted by means of LEDs or laser diodes and in turn emits light having another spectrum. For example, this technology can be used, in order to generate white mixed light using the light of blue LEDs by admixing yellow light, which is generated by exciting a phosphor-containing layer using the blue light.

For remote phosphor applications, thin luminescent substance layers such as cubic silicate minerals, orthosilicates, garnets, or nitrides are applied to surfaces of corresponding carriers. The luminescent substance layers are normally mechanically fixed using binders on a carrier and arranged on the exit side for the usage of the light emission on an optical system (lenses, collimators, etc.), wherein the light coupling can occur via air or by means of an immersion medium, for example. To ensure the most optimal possible optical connection of the optical system to the luminescent substance and avoid light losses, the most direct possible optical connection should be ensured.

In the above-mentioned applications, the luminescent substances are conventionally excited to emission by means of LEDs and/or laser diodes having high light powers. The thermal losses occurring here (for example, due to the Stokes shift during the wavelength conversion) are to be dissipated, for example, via the carrier, to avoid overheating and therefore thermally related changes, for example, worsening of the optical properties or also the destruction of the luminescent substance. Common methods for avoiding this problem include the use of a color wheel with paste application of luminescent substance or limiting the light power with which the luminescent substance layers are irradiated.

The luminescent substances, which are usually provided in powder form, do not form mechanically stable layers, i.e., abrasion-resistant and/or scratch-proof layers, without the additional use of binders, for example, silicones. However, binders are also generally used to bring together the luminescent substance particles to form a phase, which can then be applied to corresponding surfaces. Upon the use of binders for layer stabilization, however, these binders can themselves interact with the luminescent substances and therefore negatively influence the optical and thermal properties thereof, and also the service life thereof. In addition, the thermal conductivity of the binder frequently represents a limiting variable in the case of the dissipation of heat arising in the converter element.

As alternatives, converter elements are known which are formed from a ceramic including the luminescent substance or from a crystal including the luminescent substance. In particular, the luminescent substance can form the ceramic or the crystal. Such converter elements can be glued to cooling bodies, so that the heat arising therein can be dissipated. One limiting variable for the dissipation of the heat here is the thermal conductivity of the adhesive used. Furthermore, it is favorable for good heat dissipation if the converter elements are formed to be particularly thin. One limiting variable for the thickness of the converter element is, however, the mechanical stability of the converter element, which disappears with disappearing thickness, and the required handling ability during the application of the converter element to the cooling body. The converter element can have a surface area from several square millimeters up to several square centimeters or larger. This can result in a high rejection rate during the production process in the case of very thin converter elements.

### SUMMARY

In various embodiments, a converter arrangement and a method for producing a converter arrangement are provided, which at least reduces or avoids the above-mentioned disadvantages, wherein, for example, improved heat removal can be ensured and thus greater energy introduction into the converter arrangement can be made possible. Furthermore, in various embodiments, a lighting arrangement is provided, in which improved heat removal from the converter element can be ensured.

In various embodiments, a converter arrangement is provided. The converter arrangement includes a converter element, including crystal or ceramic, having at least one luminescent substance and a cooling element for dissipating heat from the converter element. The converter element and the cooling element are connected in direct physical contact with one another.

That the converter element and the cooling element are connected in direct physical contact with one another means that the contact exists directly, immediately, and in particular without a macroscopic intermediate layer, for example, made of adhesive, copper, or a soldering medium such as tin solder, between the cooling element and the converter element. For example, the distance between the converter element and the cooling element can be in the order of magnitude of nanometers, subnanometers, lattice constants, or atomic layers. This is referred to hereafter for the sake of simplicity as direct physical contact. This direct physical contact allows optimum heat dissipation from the converter element to the cooling element. This contributes to being able to introduce a large amount of energy into the converter element and being able to dissipate it rapidly and effectively, without the converter element being damaged by the large amount of energy. That the converter element including crystal or ceramic includes at least one luminescent substance can mean that the ceramic or the crystal is formed from the luminescent substance.

The luminescent substance used is embedded in the ceramic or incorporated in the crystal structure and can be a luminescent substance mixture in various embodiments, which includes a mixture made of various luminescent substances, whereby light can be generated, for example, which unifies multiple different colors. Suitable luminescent substances are known in the prior art. Typical luminescent substances are, for example, garnets or nitrides, silicates, nitrides, oxides, phosphates, borates, oxynitrides, sulfides, selenides, aluminates, tungstates, and halides of aluminum, silicon, magnesium, calcium, barium, strontium, zinc, cadmium, manganese, indium, tungsten, and other transition metals, or rare earth metals such as yttrium, gadolinium, or lanthanum, which are doped with an activator, for example, copper, silver, aluminum, manganese, zinc, tin, lead, cerium, terbium, titanium, antimony, or europium. In various embodiments of the invention, the luminescent substance is an oxidic or (oxy)nitridic luminescent substance, such as a garnet, orthosilicate, nitrido(alumino)silicate, nitride, or nitrido-orthosilicate, or a halogenide or halophosphate. Specific examples of suitable luminescent substances are strontium chloroapatite:Eu ((Sr,Ca)s(PO₄)₃Cl:Eu; SOAP), yttrium-aluminum garnet:Cer (YAG:Ce), or CaAlSiN₃:Eu. Furthermore, particles having light-scattering properties and/or auxiliary substances can be contained in the luminescent substance or luminescent substance mixture. Examples of auxiliary substances include surfactants and organic solvents. Examples of light-scattering particles are gold, silver, and metal oxide particles. The converter element can completely or only partially consist of crystal or ceramic, for example. Furthermore, the crystal converter element can be a single crystal, for example. Independently thereof, the converter element may include a matrix material, which may include diamond or Al₂O₃, for example.

According to various embodiments, the converter element and the cooling element are connected to one another as a result of the direct physical contact. As a result of the direct physical contact, the converter element and the cooling element can adhere to one another, for example, as a result of the atomic bonding forces, which act as a result of the direct physical contact between the cooling element and the converter element. The direct physical contact, for example, having a distance of an atomic order of magnitude, causes the converter element and the cooling element to adhere to one another without further auxiliary means or adhesive means or connectors. The atomic bonding forces are, for example, van der Waals forces, hydrogen bridge bonds, dipole-dipole bonds, cohesion forces, and/or adhesion forces.

According to various embodiments, the converter element can be sintered, forced on, or connected by means of hydrogen bridge bonds to the cooling element. This allows the converter element and the cooling element to be connected to one another in direct physical contact in a particularly simple and effective manner, for example, at a distance in an atomic order of magnitude or in the nanometer range or subnanometer range.

According to various embodiments, the cooling element may include metal or ceramic. This may contribute to particularly good heat dissipation by the cooling element. For example, the cooling element may include Al₂O₃, BN, or AlN, tungsten, copper, aluminum, molybdenum, tantalum, and/or rhenium. Alternatively or additionally, the cooling element may include graphite and/or graphene.

According to various embodiments, a thickness of the converter element can be less than or equal to 50 μm, in particular at less than or equal to 10 μm. The low thickness of the converter element contributes to the particularly good heat dissipation from the converter element.

According to various embodiments, the converter arrangement may include a cooling body which is coupled to the cooling element.

The cooling body allows particularly good heat dissipation from the cooling element. For example, the cooling element can be glued or soldered onto the cooling body. This allows the connection of the cooling element to the cooling body in a particularly simple manner. For example, a copper and/or tin solder layer can be formed between the cooling element and the cooling body.

In various embodiments, a method for producing the converter arrangement is provided, wherein the converter element including crystal or ceramic, which includes at least the luminescent substance, for dissipating the heat from the converter element, is connected to the cooling element such that the converter element and the cooling element are directly physically in contact with one another. The direct physical contact without intermediate layer allows optimum heat dissipation from the converter element to the cooling element. This contributes to being able to introduce a large amount of energy into the converter element and simultaneously being able to rapidly and efficiently dissipate the heat thus arising. That the converter element including crystal or ceramic includes the luminescent substance can also mean that the converter element is formed from the crystal or the ceramic.

According to various embodiments, the converter element and the cooling element can be connected to one another such that they adhere to one another as a result of the direct physical contact. The direct physical contact then not only causes the thermally favorable coupling between cooling element and converter element, but rather also ensures the solid connection between cooling element and converter element.

According to various embodiments, the converter element and the cooling element can be produced independently of one another and then connected to one another. This can contribute to a simple and cost-effective production process.

According to various embodiments, the converter element can be forced onto the cooling element.

Additionally or alternatively, the converter element can be fixed on the cooling element via hydrogen bridge bonds. This causes both the direct physical contact and also the solid connection between cooling element and converter element in a simple and effective manner.

According to various embodiments, a surface of the converter element and a surface of the cooling element can be produced with a slight roughness or processed accordingly, for example, post-processed, such that the converter element and the cooling element adhere to one another on the corresponding surfaces as a result of atomic bonding forces after they are brought into direct physical contact with one another. This allows the converter element and the cooling element to be connected to one another in direct physical contact in a particularly simple and effective manner, for example, without adhesive. For example, the atomic bonding forces can have van der Waals forces and/or hydrogen bridge bonds.

According to various embodiments, the surface of the cooling element and/or the surface of the converter element having the slight roughness can be produced or processed by polishing, grinding, etching, pickling, or sandblasting the corresponding surfaces or processing them with the aid of laser ablation. This allows the surfaces having the slight roughness to be generated in a particularly simple and effective manner. The slight roughness can mean, for example, that the roughness is in the range of atomic orders of magnitude. For example, the surface of the cooling element and the surface of the converter element can be produced or processed with a roughness in the nanometer range.

According to various embodiments, the cooling element and the converter element can be brought into contact with one another in a vacuum. This contributes to macroscopic contaminants such as dust not moving between the two surfaces of the cooling element and the converter element or gas inclusions not arising between the surfaces, which in turn contributes to a solid connection and good heat coupling between the converter element and the cooling element. The vacuum can be, for example, an atmosphere having a pressure in coarse vacuum, fine vacuum, high vacuum, ultrahigh vacuum, or extreme vacuum.

According to various embodiments, before the cooling element is brought into contact with the converter element, liquid can be applied to at least one of the two surfaces, so that after they are brought into contact, the surfaces contacted with one another adhere to one another at least partially as a result of hydrogen bridge bonds. This reinforces the atomic bonding forces, as a result of which the converter element and the cooling element adhere to one another.

According to various embodiments, the converter element can be produced on the cooling element. This can allow the converter element and the cooling element to be connected to one another in direct physical contact in a simple manner.

According to various embodiments, the converter element can be sintered or grown on the cooling element. For example, the converter element can be sintered on the cooling element if the converter element substantially consists of ceramic, and the converter element can be grown on the cooling element if the converter element substantially consists of crystal. This contributes in a particularly effective manner to forming the converter element on the cooling element.

According to various embodiments, the cooling element can be produced or formed on the converter element by coating the cooling element with a slurry, which includes the luminescent substance. The slurry is sintered on the cooling element, wherein the sintered slurry represents the converter element. In other words, the slurry is baked on the cooling element. This allows the converter element and the cooling element to be connected to one another in direct physical contact in a particularly simple and effective manner, for example, such that the distance between the converter element and the cooling element corresponds to an atomic order of magnitude or is in the nanometer range or subnanometer range. The slurry can be applied to the cooling element, for example, by means of electrophoresis, squeegeeing, or a printing method.

According to various embodiments, the converter element connected to the cooling element can be at least partially ablated, so that a thickness of the converter element is at least partially decreased, for example, to 50 μm or less, for example, to 10 μm or less. The ablation can be performed, for example, by means of grinding, etching, polishing, or pickling or by means of laser ablation. The low thickness of the converter element contributes to the particularly good heat dissipation from the converter element, while the stability of the converter element is ensured by the cooling element.

In various embodiments, a lighting arrangement includes the converter arrangement and an excitation source, for example, a light source, which illuminates the converter arrangement.

The lighting arrangement may include as an excitation source, for example, one or more laser light sources and/or one or more LEDs and/or one or more superluminescence diodes. The excitation source may also include electromagnetic radiators, for example, flash lamps, ultraviolet radiators, infrared radiators, x-ray radiators. The excitation source may also include corpuscular radiators, for example, ion emitters and/or electron emitters. The excitation source can have a predefined distance to the converter arrangement, for example.

The lighting arrangement can be used, for example, in a projector or an endoscope or in any arbitrary other device, in which a high light density is desirable or necessary.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a lighting arrangement according to various embodiments;

FIG. 2 shows a converter arrangement according to various embodiments;

FIG. 3 shows a converter arrangement according to various embodiments;

FIG. 4 shows a converter arrangement according to various embodiments;

FIG. 5 shows a flow chart according to various embodiments of a method for producing the converter arrangement;

FIG. 6 shows a flow chart according to various embodiments of the method for producing the converter arrangement; and

FIG. 7 shows a flow chart according to various embodiments of the method for producing the converter arrangement.

### DETAILED DESCRIPTION

In the following detailed description, reference is made to the appended drawings, in which specific embodiments are shown for illustration, in which the invention can be performed. It is apparent that the features of the various embodiments described herein can be combined with one another, if not specifically indicated otherwise. The following detailed description is therefore not to be understood in a restrictive sense, and the scope of protection of the present invention is defined by the appended claims. In the scope of this description, the term “coupled” is used to describe both indirect or direct coupling. Identical or similar elements are provided with identical reference signs in the figures, if this is appropriate.

FIG. 1 shows a lighting arrangement 10 according to various embodiments, having a light source 12, which generates a light beam 14. The light source 12, is a laser diode, for example. Alternatively thereto, the light source 12 can be a light emitting diode (LED) or another light source. The light beam 14 is oriented on to a converter arrangement 20 fastened on a carrier 16. In other words, the light source 12 illuminates or irradiates the converter arrangement 20. The light source 12 has a predefined distance to the converter arrangement 20 and therefore is not in direct physical contact with the converter arrangement 20. Alternatively thereto, the light source 12 can be in direct physical contact with the converter arrangement 20. The carrier 16 can be a part of a color wheel, for example, of a projector, for example. Alternatively or additionally, the carrier 16 may include a cooling device. The irradiated converter arrangement 20 in turn emits light beams 22. Alternatively, the lighting arrangement 10 may include multiple light sources 12 and/or multiple converter arrangements 20.

The lighting arrangement 10 is arranged in the projector. Alternatively thereto, the lighting arrangement can be arranged in an endoscope, for example.

FIG. 2 shows the converter arrangement 20 having a cooling element 24 and having a converter element 26 according to various embodiments. The converter element is formed from ceramic and contains at least one luminescent substance. The luminescent substance is excited to luminesce with the aid of the light beam 14. The converter element 26 and the cooling element 24 are in direct physical contact, for example, connected to one another directly, immediately, or without macroscopic intermediate layer, for example, without adhesive, copper, or a soldering medium such as tin solder. The distance between the converter element 26 and the cooling element 24 is in the range of atomic distances, for example, in particular a few to several angstrom and/or is in the nanometer range or subnanometer range and can be a few nanometers or less. The cooling element 24 and the converter element 26 adhere to one another as a result of the direct physical contact, for example, as a result of atomic bonding forces, which act between the cooling element 24 and the converter element 26.

The luminescent substance used is embedded in the ceramic of the converter element 26 and, in various embodiments, can be a luminescent substance mixture, which includes a mixture made of various luminescent substances, whereby light can be generated which unifies multiple different colors, for example. Suitable luminescent substances are known in the prior art. Typical luminescent substances are, for example, garnets, silicates, nitrides, oxides, phosphates, borates, oxynitrides, sulfides, selenides, and halides of aluminum, silicon, magnesium, calcium, barium, strontium, zinc, cadmium, manganese, indium, tungsten, and other transition metals, or rare earth metals such as yttrium, gadolinium, or lanthanum, which are doped with an activator, for example, copper, silver, aluminum, manganese, zinc, tin, lead, cerium, terbium, titanium, antimony, or europium. In various embodiments of the invention, the luminescent substance is an oxidic or (oxy)nitridic luminescent substance, such as a garnet, orthosilicate, nitrido(alumino)silicate, or nitrido-orthosilicate, or a halogenide or halophosphate. Specific examples of suitable luminescent substances are strontium chloroapatite:Eu ((Sr,Ca)₅(PO₄)₃Cl:Eu; SCAP), yttrium-aluminum garnet:Cer (YAG:Ce), or CaAlSiN₃:Eu. Furthermore, particles having light-scattering properties and/or auxiliary substances can be contained in the luminescent substance or luminescent substance mixture. Examples of auxiliary substances include surfactants and organic solvents. Examples of light-scattering particles are gold, silver, and metal oxide particles. Independently thereof, the converter element may include a matrix material, which may include diamond or Al₂O₃, for example. Alternatively, the converter element 26 can be completely or partially formed from a crystal, in particular a single crystal, or include a crystal. The luminescent substance or the luminescent substance mixture is optionally incorporated in the crystal structure of the crystal.

The converter element 26 made of ceramic is sintered on the cooling element 24, which is explained in greater detail hereafter. Alternatively thereto, the converter element 26 can be forced on the cooling element 24 and/or connected by means of hydrogen bridge bonds. If the converter element 26 substantially consists of crystal, the crystal can be forced on the cooling element 24 and/or connected by means of hydrogen bridge bonds or grown directly onto the cooling element 24.

The cooling element 24 is also formed from ceramic, for example, from Al₂O₃, BN, or AlN. Alternatively or additionally, the cooling element 24 can only partially have the ceramic and/or include graphite or be formed therefrom. Alternatively or additionally, the cooling element 24 may include metal or be formed therefrom. In particular, the cooling element 24 may include tungsten, copper, aluminum, molybdenum, tantalum, and/or rhenium.

A thickness 28 of the converter element 26 is 10 μm. Alternatively thereto, the thickness 26 can merely be less than or equal to 50 μm or also less than 10 μm.

FIG. 3 shows the converter arrangement 20 according to various embodiments, in which the converter element 26 a matrix material 30. The matrix material is Al₂O₃ in various embodiments. Alternatively thereto, the matrix material can be diamond.

FIG. 4 shows the converter arrangement 20 according to various embodiments having a cooling body 32, which is coupled to the cooling element 24 via a connecting layer 34 for improved heat dissipation. The connecting layer 34 substantially includes adhesive. Alternatively thereto, the connecting layer 34 may include a tin solder layer and/or a copper layer or a heat conduction medium. The coupling between the cooling body 32 and the cooling element 24 is formed such that a heat transport is simply and effectively possible from the cooling element 24 to the cooling body 32. This can be achieved, for example, by providing the heat conduction paste between the surfaces which are in contact. Furthermore, a channel system can also be provided in the cooling body 32 close to the cooling element 24, through which a cooling fluid circulates, to provide an additional heatsink. The selection of the type and linkage of such cooling means for the removal of the heat can be adapted to the individual requirements according to various embodiments, so that the converter element 26 can be irradiated with high powers, without being impaired in its mode of operation. The connection between cooling body 32 and the cooling element 24 can be produced by solders. Alternatively thereto, the cooling element 24 and the cooling body 32 can also be connected to one another in direct physical contact and adhere to one another as a result of the direct physical contact, for example.

FIG. 5 shows a flow chart of a method for producing the converter arrangement 20 according to various embodiments.

In a step S2, the cooling element 24 and the converter element 26 are provided. The converter element 26 is entirely or partially formed as crystal or ceramic, wherein the luminescent substance is incorporated in the crystal lattice or the luminescent substance is embedded in the ceramic, respectively. Forming the converter element 26 from crystal or ceramic can contribute to heat, which arises in the event of an energy introduction into the converter element 26, being able to be transported rapidly within the converter element 26. Therefore, in various embodiments, a crystal structure or a ceramic is used which has a particularly high coefficient of heat conduction. The cooling element 24 is preferably formed from a material having a high coefficient of thermal conductivity. For example, the cooling element 24 can have metal or ceramic or can be formed completely thereof, for example, as explained above.

In a step S4, the converter element 26, for dissipating the heat from the converter element 26, is connected to the cooling element 24 such that the converter element 26 and the cooling element 24 are physically in direct contact with one another.

The direct physical contact without a macroscopic intermediate layer allows optimum heat dissipation from the converter element 26 to the cooling element 24. This contributes to being able to introduce a large amount of energy into the converter element 24 and simultaneously being able to dissipate the heat thus arising rapidly and efficiently. In addition, the direct physical contact causes the adhesion of the converter element 26 and the cooling element 24 to one another as a result of atomic bonding forces, which act between the converter element 26 and the cooling element 24.

For example, the combination of a converter element 26 made of ceramic or crystal, a cooling element 24 made of ceramic or metal, and the direct physical contact between the cooling element 24 and the converter element 26 contribute to particularly good, effective, and rapid removal of the heat arising in the event of the irradiation of the converter element 26.

In a step S6, which can optionally be executed, the converter element 26 connected to the cooling element 24 is partially ablated, so that a thickness of the converter element 26 is decreased. After the ablation, the thickness of the converter element 26 is approximately 10 μm. Alternatively thereto, the thickness can also be ablated to 50 μm or less, for example, in particular to less than 10 μm. The ablation is performed by means of grinding. Alternatively thereto, the ablation can be performed, for example, by etching, polishing, or pickling, or by laser ablation. The low thickness of the converter element 26 contributes to the particularly good heat dissipation from the converter element 26. The stability of the converter element 26 is ensured by the cooling element 24.

FIG. 6 shows a method for producing the converter arrangement according to various embodiments, in which the cooling element 24 and the converter element 26 are produced independently of one another and are subsequently connected to one another. In particular, the converter element 26 is forced on the cooling element 24. Alternatively thereto, the cooling element 24 and the converter element 26 can be brought into direct physical contact with one another in another manner after the production thereof.

In a step S10, the converter element 26 and the cooling element 24 are provided according to step S2 of the embodiment of the method shown in FIG. 5.

In a step S12, a surface of the converter element 26 and a surface of the cooling element 24 are processed such that a roughness of the processed surfaces is sufficiently slight that the converter element 26 and the cooling element 24 adhere to one another on the processed surfaces as a result of atomic bonding forces, for example, van der Waals forces and/or hydrogen bridge bonds after they are brought into direct physical contact with one another. This allows the converter element 26 and the cooling element 24 to be connected in direct physical contact with one another in a particularly simple and effective manner, for example, without adhesive. The slight roughness is generated by polishing of the surfaces. Alternatively thereto, the surfaces can also be etched, ground, sandblasted, or pickled, or processed with the aid of laser ablation or electro-polishing. This allows the surfaces having the slight roughness to be generated in a particularly simple and effective manner. The slight roughness can mean, for example, that the roughness is in the range of atomic orders of magnitude. For example, the surface of the cooling element 24 and the surface of the converter element 26 can be provided with a roughness in the nanometer range or subnanometer range.

In a step S14, which can optionally be executed, the cooling element 24 and the converter element 26 are introduced into a vacuum atmosphere to be brought into contact with one another on the processed surfaces. This contributes to macroscopic contaminants not moving between the processed surfaces of the cooling element 24 and the converter element 26, which in turn contributes to a solid connection and good heat coupling between the converter element 26 and the cooling element 24.

In a step S15, which can optionally be executed, for example, additionally or alternatively to step S14, before the cooling element 24 is brought into contact with the converter element 26, liquid, for example, pure water or siloxane, is applied to at least one of the two processed surfaces, so that after they are brought into contact, the surfaces contacted with one another adhere to one another at least partially as a result of hydrogen bridge bonds. This reinforces the atomic bonding forces as a result of which the converter element 26 and the cooling element 24 adhere to one another. It is to be noted that the liquid is nearly completely removed except for a few, for example, one to two atomic layers between the surfaces after the joining together as a result of the extremely smooth surfaces, so that a direct physical contact can still be referred to, for example, at an atomic order of magnitude, between the cooling element 24 and the converter element 26.

In step S16, the converter element 26 and the cooling element 24 are connected to one another, by bringing them into direct physical contact with one another.

In step S18, the thickness of the converter element 26 can be decreased in accordance with step S6 of the embodiment of the method shown in FIG. 5.

FIG. 7 shows a method for producing the converter arrangement according to various embodiments, in which the converter element 26 is produced directly on the cooling element 24. For example, the converter element 26 made of ceramic is produced, for example, sintered, directly on the cooling element 24. If the converter element 26 is made of crystal, the crystal can also be grown directly on the cooling element. Furthermore, the converter element 26 can be produced on the cooling element 24 in other manners.

In a step S20, the cooling element 24 is provided according to step S2 of the embodiment of the method shown in FIG. 5.

In a step S22, the cooling element 24 is connected to the converter element 26 by coating the cooling element 24 with a slurry, which includes the luminescent substance and which forms the converter element 26 after the sintering. The slurry can be applied to the cooling element 24 by means of electrophoresis, squeegeeing, or a printing method, for example. The slurry can subsequently be dried. The slurry layer can be formed at different thicknesses depending on the application method, for example, particularly thin, for example, in the micrometer range.

In a step S24, the slurry is sintered on the cooling element 24, for example, the cooling element 24 having the slurry 24 is heated and the slurry is baked. This allows the converter element 26 and the cooling element 24 to be connected in direct physical contact with one another in a particularly simple and effective manner, for example, such that the distance between the converter element 26 and the cooling element 24 is in the range of atomic distances or is in the nanometer range. One advantage in this procedure is that only slight demands can be placed on the roughness of the surfaces to be connected.

In step S26, the thickness of the converter element 26 can be decreased corresponding to step S6 of the embodiment of the method shown in FIG. 5.

The invention is not limited to the embodiments shown. For example, further methods are conceivable, which are suitable for bringing the cooling element 24 and the converter element 26 into direct physical contact with one another, for example, such that the two adhere to one another.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

### LIST OF REFERENCE NUMERALS

10 lighting arrangement
12 light source
14 light beam
16 carrier
20 converter arrangement
22 light beams colored
24 cooling element
26 converter element
28 thickness
30 matrix material
32 cooling body
34 connecting layer
S2-S26 steps S2 to S2

1. A converter arrangement comprising:
a converter element, comprising crystal or ceramic, having at least one luminescent substance, and
a cooling element for dissipating heat from the converter element,
wherein the converter element and the cooling element are connected in direct physical contact with one another.

2. The converter arrangement as claimed in claim 1, wherein the converter element and the cooling element adhere to one another as a result of the direct physical contact.

3. The converter arrangement as claimed in claim 2, wherein the converter element is sintered, forced on, grown, or connected by means of hydrogen bridge bonds to the cooling element.

4. The converter arrangement as claimed in claim 1, wherein the cooling element comprises ceramic or metal.

5. The converter arrangement as claimed in claim 1, wherein a thickness of the converter element is less than or equal to 10 μm.

6. The converter arrangement as claimed in claim 1, further comprising:
a cooling body, which is coupled to the cooling element.

7. A method for producing a converter arrangement, wherein a converter element comprising crystal or ceramic, having at least one luminescent substance, for dissipating heat from the converter element, is connected to a cooling element such that the converter element and the cooling element are physically in direct contact with one another.

8. The method as claimed in claim 7, wherein the converter element and the cooling element are connected to one another such that they adhere to one another as a result of the direct physical contact.

9. The method as claimed in claim 7, wherein the cooling element and the converter element are produced independently of one another and then connected to one another.

10. The method as claimed in claim 9, wherein the converter element is forced on the cooling element and/or connected by means of hydrogen bridge bonds.

11. The method as claimed in claim 10, wherein a surface of the converter element and a surface of the cooling element are processed such that a roughness of the processed surfaces is sufficiently slight that the converter element and the cooling element adhere to one another on the corresponding surfaces as a result of atomic bonding forces after they are brought into physical contact with one another.

12. The method as claimed in claim 11, wherein the surface of the cooling element and/or the surface of the converter element having the slight roughness are produced or processed by polishing, grinding, etching, pickling, or sandblasting the corresponding surfaces.

13. The method as claimed in claim 10, wherein the cooling element and the converter element are brought into contact with one another in a vacuum.

14. The method as claimed in claim 10, wherein before the cooling element is brought into contact with the converter element, liquid is applied to at least one of the two surfaces, so that after they are brought into contact, the surfaces contacted with one another adhere to one another at least partially as a result of hydrogen bridge bonds.

15. The method as claimed in claim 7, wherein the converter element is produced on the cooling element.

16. The method as claimed in claim 15, wherein the converter element is sintered or grown on the cooling element.

17. The method as claimed in claim 16, wherein the cooling element is connected to the converter element by coating the cooling element with a slurry, which comprises the luminescent substance, and wherein the slurry is sintered on the cooling element, wherein the sintered slurry is the converter element.

18. The method as claimed in claim 7, wherein the converter element connected to the cooling element is at least partially ablated, so that a thickness of the converter element is at least partially decreased.

19. A lighting arrangement, comprising:
a converter arrangement, and
an excitation source, which irradiates the converter arrangement, the converter arrangement comprising:
a converter element, comprising crystal or ceramic, having at least one luminescent substance, and
a cooling element for dissipating heat from the converter element,
wherein the converter element and the cooling element are connected in direct physical contact with one another.
